(19) United States
(12) Patent Application Publication
(10) Pub. No.: US 2024/0133622 A1
(43) Pub. Date: Apr. 25, 2024

(54) Froster System to Chill Drinking Vessels for Integration into a Refrigerator

(71) Applicant: Albert Reasonover, Osceola, IN (US)

(72) Inventor: Albert Reasonover, Osceola, IN (US)

(21) Appl. No.: 18/492,626

(22) Filed: Oct. 22, 2023

Related U.S. Application Data
(60) Provisional application No. 63/380,708, filed on Oct. 24, 2022.
(60) Provisional application No. 63/507,075, filed on Jun. 8, 2023.

(51) Int. Cl. F25D 31/00; F25D 23/02

(52) U.S. Cl. CPC F25D 31/008; F25D 23/028; F25D 2331/808

(57) ABSTRACT

A froster system is provided that dispenses liquid CO2 from a high-pressure CO2 cylinder through a CO2-dispensing nozzle that is disposed within a refrigerator. The froster system efficiently sanitizes and chills, freezes, or ices the vessel placed at the nozzle. The froster system includes the high-pressure CO2 cylinder in fluid communication with the CO2-dispensing nozzle, cylinder-to-nozzle tubing to connect the CO2 cylinder to the CO2-dispensing nozzle, and a controller to convey the input of the user to actuate the froster system to output liquid CO2.

### FIELD OF INVENTION

This invention relates generally to a froster system using carbon dioxide (CO2) for icing, freezing, and/or chilling drinking vessels, and, more particularly, to a froster system for integration into a refrigerator.

### BACKGROUND OF THE INVENTION

A cold drink served in a frosted glass is a delightful refreshment. Stemmed glasses for wine, mugs for beer, or tumblers for soft drinks may be advantageously frosted, chilled, iced, or frozen to enhance the visual presentation of the drink, to improve the perceived taste of the drink, and to encourage enjoyment of the drink.

A common method to procure iced glasses for receiving drinks is to place clean glasses into a freezer, wait a sufficient time for the glasses to freeze, and then open the freezer to retrieve the frozen glasses. However, this method is logistically complex. Preparation is needed many hours in advance of the desired time of use. This method necessitates hours of freezing time and requires that a home has a significantly larger freezer to accommodate the number of glasses that will be required for the day. It is a rare family that even has enough extra freezer space to store one frozen glass per family member per day, and more than one iced glass a day is likely to be desired. Thus, this method is impractical in most cases, and a faster froster system is wanted.

To address the need to frost, chill, and/or freeze a glass more quickly, liquid CO2 from a high-pressure cylinder has been used. For example, a CO2 glass chiller sold under the trademark INNOVECO is commercially available at www.innoveco2.com. This countertop-mounted CO2 glass chiller states it can chill a glass in 3-6 seconds. It provides an upper nozzle within a hood into which the glass is raised. Liquid CO2 is drawn by a siphon tube (also known as a “dip tube”) from the high-pressure cylinder and is routed to the nozzle. When activated the liquid CO2 is dispensed onto the glass to be frosted which has been positioned at the nozzle.

Other glass frosters/chillers are known, such as the Apparatus for Icing or Freezing or Frosting Containers or Hollow Bodies, More Particularly Drinking-Glasses disclosed in U.S. Pat. No. 4,237,697 by Cherbland. In the Cherbland system, a tank containing liquified gas under pressure is supplied through a valve to a nozzle which sprays the liquefied gas into the interior of the drinking glass.

Though both the commercially available CO2 glass chiller and the frosting apparatus by Cherbland dispense liquefied gas to chill, freeze, or frost a drinking vessel, both require sufficient countertop space for the high-pressure cylinder, and both occupy a significant area of a countertop for the froster itself. Since kitchens rarely have extra counter space, these solutions are less than ideal. It would be advantageous to chill, freeze, or frost a drinking vessel without requiring a homeowner to give up limited kitchen, countertop, or table space.

Accordingly, there is a need for a froster system that can be installed in a location that minimizes the loss of kitchen space while providing a quick and convenient means to frost a beverage vessel, so that a beverage can be served in an appealing manner and can be maintained for a longer period at a preferred low temperature.

### BRIEF SUMMARY OF THE INVENTION

The present invention is directed to a froster system that dispenses liquid carbon dioxide (CO2) through a CO2-dispensing nozzle; the nozzle is disposed within a water/ice dispenser area in a door of a refrigerator. The froster system efficiently chills, freezes, or ices the vessel placed at the nozzle when the CO2 is dispensed. The froster system provides additional value in that the vessel is also sanitized when frosted. Because the froster system is designed to be integrated into a standard refrigerator (such as into the ice/water dispenser area), the froster does not require any additional kitchen space, yet provides a convenient means to quickly frost a drinking vessel for optimum appeal of the beverage.

The froster system includes a high-pressure CO2 cylinder, a valve to allow or prevent CO2 flow, control electronics, a CO2-dispensing nozzle disposed within the refrigerator, and connecting gas flow pathway tubing to connect the cylinder to the nozzle. The term “within the refrigerator” means stored in a portion of the refrigerator, carried by the refrigerator, or supported by the refrigerator, for example, stored and supported in the interior of the refrigerator (such as inside the refrigerator door, in the refrigerator shelf area, or within a drawer of a refrigerator), stored and carried within a front area of a refrigerator door behind a refrigerator facade door, supported on the front of a refrigerator door, or inset within the front of a refrigerator door.

In one embodiment of the invention, the nozzle of the froster system is installed in a conventional inset dispenser space within the front of a door of a refrigerator. In this embodiment, the froster nozzle is installed at the location where the water, cubed ice, and crushed ice are dispensed. In another embodiment, the froster nozzle is installed alone in an inset dispenser area, separate from the ice/water dispenser. In a further embodiment, the froster nozzle is installed in an interior area of the refrigerator. In an additional embodiment, the froster nozzle is installed at the front of the refrigerator, but behind a facade door of the refrigerator.

Dispensing of the CO2 may be actuated manually or by an electronic control panel. In some aspects of the invention, a safety shield can be manually or automatically closed over the opening of the dispensing area to prevent a user from direct contact with the liquid CO2.

Other embodiments provide for differing dispensing options. In one embodiment of the invention, cubed ice, crushed ice, water, and CO2 for frosting a vessel are dispensed. In another embodiment of the invention, sparkling water is additionally dispensed. In this embodiment, the CO2 cylinder is utilized both for frosting glasses and for generation of the sparkling water. In a further embodiment, the CO2 is dispensed in two locations. A first CO2-dispensing nozzle is disposed in the water/ice dispenser area. A second CO2-dispensing nozzle is disposed within a handheld wand that allows freedom of movement, such as may be desired to frost a container or object that does not easily fit within the water/ice dispenser area.

Multiple aspects of the invention, which can be utilized with the embodiments are also disclosed. These aspects include, inter alia, variations in the placement of the CO2 nozzle, means to position the vessel to be chilled, suitable locations for the CO2 cylinder, and alternative arrangements of the safety shield.

Installing the froster system within the refrigerator minimizes the loss of kitchen space while providing a quick and convenient means to frost a serving vessel. The vessel to be chilled will typically be a beverage glass, mug, cup, cocktail glass, or the like. However, additionally, the inventive froster system can be used to sanitize items or to frost other serving ware (such as a salad bowl), storage vessels, food products (such as to quickly cool food before serving, during cooking, or when ready to store leftovers), and even non-kitchen vessels or objects that may benefit from quick cooling.

In one aspect of the invention, the replaceable CO2 cylinder is accessed from the exterior of the refrigerator.

In a further aspect of the invention, the replaceable CO2 cylinder is accessed from the interior of the refrigerator.

In an additional aspect of the invention, the CO2 cylinder is disposed in a refrigerator door and accessed from the interior of the refrigerator.

In another aspect of the invention, the CO2 cylinder is disposed in a refrigerator door and is accessed from the exterior of the refrigerator.

In an additional aspect of the invention, the CO2 cylinder is disposed at the bottom of the refrigerator.

In a further aspect of the invention, the CO2 cylinder is located remotely from the refrigerator and not within the refrigerator; for example, the CO2 cylinder may be locations in a cabinet nearby the refrigerator, under the sink, in a basement, or in a garage or other work area.

In another aspect of the invention, a dual conduit CO2 high pressure cylinder is provided in which one conduit provides liquid CO2 for frosting and one conduit provides CO2 gas for sparkling water.

In an additional aspect of the invention, a safety shield is included. In this aspect, the safety shield may be lowered from the top of the dispensing area, raised from the bottom of the dispensing area, or slid from a side of the dispensing area to enclose the dispensing area. In this aspect, the safety shield may be perforated or solid. Additionally, in this aspect, the safety shield may be extended and retracted manually or through electronic and mechanical means.

In a further aspect of the invention, there is no safety shield.

In another aspect of the invention, the floor platform of the dispensing area can be raised and lowered.

In a further aspect of the invention, the CO2-dispensing nozzle includes a guard to protect glassware from damage.

In an additional aspect of the invention, the CO2 nozzle extends and retracts.

In a further aspect of the invention, the CO2 nozzle is located at the top of the dispensing area.

In another aspect of the invention, the CO2 nozzle is located at the bottom of the dispensing area.

In an additional aspect of the invention, the CO2 nozzle is located on the exterior of a refrigerator door behind a refrigerator facade door.

In another aspect of the invention, the CO2 nozzle is located on the interior of a refrigerator door.

In a further aspect of the invention, a CO2 nozzle is disposed on a handheld wand that can be manually moved a short distance from the refrigerator.

In an additional aspect of the invention, two CO2 nozzles may be disposed within the refrigerator. In this aspect, both nozzles may be stationary, or one nozzle may comprise a stationary CO2 nozzle and one nozzle may comprise a handheld wand type CO2 nozzle.

In an aspect of the invention, an extendible/retractable glass holder is included near the CO2 nozzle.

In an aspect of the invention, dispensing of the CO2 is manually actuated.

In a further aspect of the invention, dispensing of the CO2 is electronically actuated.

In another aspect of the invention, a timer controls the time of the dispensing of the CO2.

In an additional and preferred aspect of the invention, the timing of the dispensing of the CO2 is manually controlled.

In a further aspect of the invention, a safety code feature is provided to control locking and unlocking of the frosting system, which can provide extra safety to children of the household.

The object of the invention is to provide a froster system to chill drinking vessels that is integrated into a refrigerator which gives an improved performance over the above-described prior art systems and methods.

These and other objects, features, and advantages of the present invention will become more readily apparent from the attached drawings and from the detailed description of the preferred embodiments which follow.

### BRIEF DESCRIPTION OF THE SEVERAL VIEWS OF THE DRAWINGS

The preferred embodiments of the invention will hereinafter be described in conjunction with the appended drawings, provided to illustrate and not to limit the invention, where like designations denote like elements.

FIG. 1 is a front view of a dispenser portion of a glass froster system of an embodiment of the invention with a froster CO2-dispensing nozzle disposed within a conventional ice/water dispensing area that is inset in the front of a refrigerator door.

FIG. 2 is a front view of a portion of the glass froster system of an embodiment of the invention located within the refrigerator door ice/water dispensing area, which illustrates an upper CO2 nozzle that can be extended downwardly into the vessel to be frosted and illustrates a safety shield disposed at the top of the dispensing area that can be manually or mechanically lowered.

FIG. 3 is a front view of a portion of the glass froster system of an embodiment of the invention disposed within the refrigerator door ice/water dispensing area, which illustrates the aspects in which the safety shield is manually or mechanically lowered from the top of the dispensing area and in which the glass froster system includes an extendable upper CO2 nozzle, which is extended.

FIG. 4 is a front view of a portion of the glass froster system of an embodiment of the invention disposed within the ice/water dispensing area, which illustrates the aspects in which an upper extendable CO2 nozzle is extended into the vessel to be frosted and in which the dispensing area is fully enclosed by the safety shield.

FIG. 5 is a front view of a portion of a glass froster system of an embodiment of the invention disposed within the ice/water dispensing area, which illustrates the aspect in which a dispensing area floor platform can be raised to position the vessel to be frosted near the CO2 nozzle.

FIG. 6 is a front view of a portion of a glass froster system of a second embodiment of the invention disposed within the ice/water dispensing area, which includes an additional carbonated water dispenser, and which illustrates the aspects in which the safety shield is raised from the bottom, and in which the upper CO2 nozzle is disposed at a side region of the dispensing area and is separate from the ice/water dispenser.

FIG. 7 is a front view of a portion of the glass froster system of an embodiment of the invention, which illustrates the aspect in which the CO2 nozzle is disposed within the lower portion of the dispensing area.

FIG. 8 is a front view of a portion of the glass froster system of an embodiment of the invention, which illustrates the aspects in which the CO2 nozzle is disposed within the dispensing area floor platform and in which a mechanical/robotic holder/gripper is installed to hold the vessel to be chilled/frosted.

FIG. 9 is a front view of the ice/water dispensing area of FIG. 8 in which the mechanical holder/gripper is holding the vessel to be chilled/frosted.

FIG. 10 is a front view of the interior of the refrigerator of an embodiment of the invention which illustrates the aspect in which the CO2 cylinder is disposed within the interior of the refrigerator door.

FIG. 11 is a front view of the refrigerator of an embodiment of the invention and of a nearby cabinet which illustrates the aspect in which the CO2 cylinder is disposed within a nearby cabinet and in which cylinder-to-nozzle tubing connects the CO2 cylinder to the CO2-dispensing nozzle.

FIG. 12 is a front view of the refrigerator of an embodiment of the invention which illustrates the aspect in which the CO2 cylinder is disposed at the bottom of the refrigerator and/or below the openable and closeable refrigerator doors.

FIG. 13 is a front view of a refrigerator with open doors illustrating the CO2 nozzle of an embodiment of the invention disposed within the ice/water dispensing area and located inset within a refrigerator internal door and behind a refrigerator facade door.

FIG. 14 is a front view of a refrigerator with the right refrigerator door closed, the left internal refrigerator door closed, and only the refrigerator facade door open, which illustrates the CO2 nozzle of an embodiment of the invention disposed within the ice/water dispensing area and located inset within a refrigerator internal door and behind a refrigerator facade door.

FIG. 15 is a front view of a refrigerator with open doors illustrating the CO2 nozzle of an embodiment of the invention disposed within the ice/water dispensing area and located within the inner portion of a refrigerator door.

FIG. 16 is a front view of a refrigerator with open doors illustrating the CO2 nozzle of an embodiment of the invention disposed within the ice/water dispensing area and located within the inner portion of a refrigerator door and additionally illustrating an extendible/retractable holder for the article to be frosted.

FIG. 17 is a front view of a refrigerator illustrating the CO2 nozzle of an embodiment of the invention disposed within the ice/water dispensing area and additionally illustrating a separate handheld wand CO2 nozzle.

FIG. 18 is a front view of a refrigerator with only the refrigerator facade door open which illustrates the CO2 nozzle of an embodiment of the invention disposed within the ice/water dispensing area and located inset within a refrigerator internal door and behind a refrigerator facade door, and which additionally illustrates a separate handheld wand CO2 nozzle.

FIG. 19 is a front view of a refrigerator with open doors that illustrates the CO2 nozzle of an embodiment of the invention disposed within the ice/water dispensing area that is located in the interior of a refrigerator door, and that additionally illustrates a separate extendable handheld wand CO2 nozzle.

FIG. 20 is a front view of a CO2 nozzle of a handheld wand of an embodiment of the invention in which the CO2 nozzle and the nozzle guard are small enough to be received into the vessel to be frosted.

FIG. 21 is a front view of a CO2 nozzle of a handheld wand of an embodiment of the invention in which the CO2 nozzle and the nozzle guard have a diameter substantially equal to the diameter of the vessel to be frosted.

FIG. 22 is a front view of a CO2 nozzle of a handheld wand of an embodiment of the invention in which the CO2 nozzle and the nozzle guard have a diameter larger than the diameter of the vessel to be frosted.

FIG. 23 is a diagram of the froster system of an embodiment of the present invention in which a CO2 nozzle is disposed in the ice/water dispenser area in which ice cubes, crushed ice, water, and CO2 for chilling/frosting are dispensed.

FIG. 24 is a diagram of the froster system of an embodiment of the present invention in which a CO2 nozzle is disposed in the ice/water dispenser area in which ice cubes, crushed ice, water, sparkling water, and CO2 for chilling/frosting are dispensed.

FIG. 25 is a diagram of the froster system of an embodiment of the present invention in which a first CO2 nozzle is disposed in the ice/water dispenser area and a second CO2 nozzle is carried by a handheld wand that can be extended from the refrigerator the length of the CO2 hose.

Like reference numerals refer to like parts throughout the several views of the drawings.

### DETAILED DESCRIPTION OF THE INVENTION

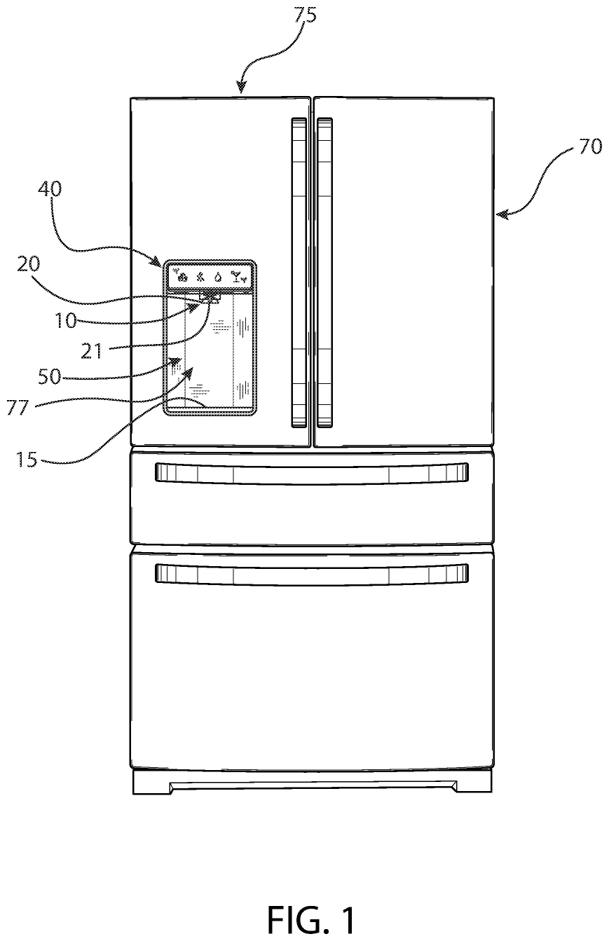

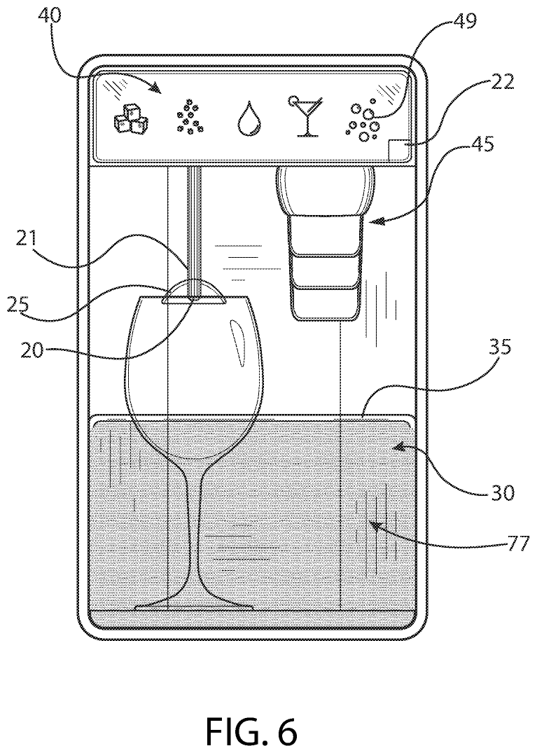

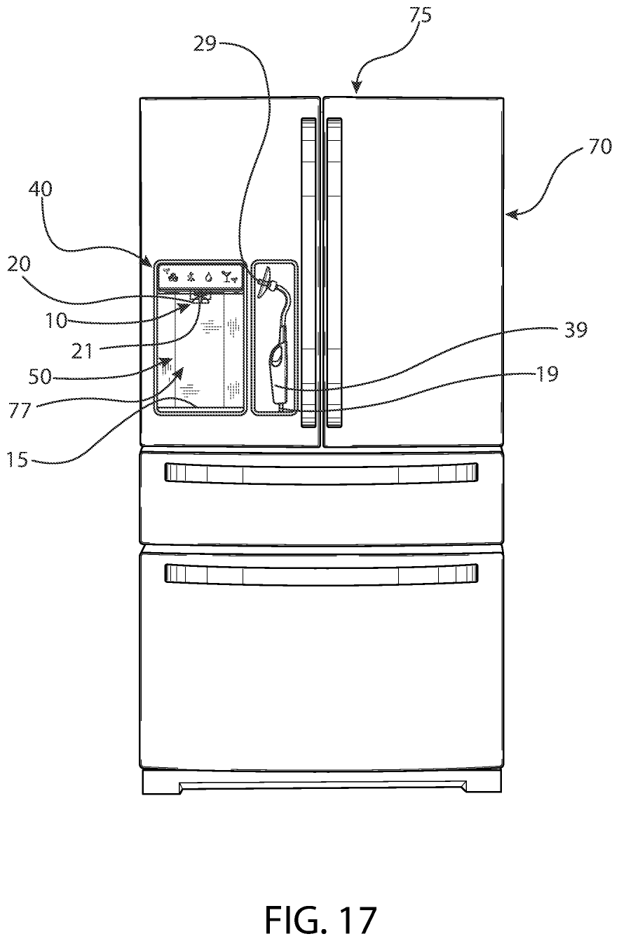

Shown throughout the figures, the present invention is directed toward a froster system using carbon dioxide (CO2), shown generally as reference number 10, that is integrated into a refrigerator, which is illustrated in accordance with the embodiments of the present invention. In one embodiment of the invention, shown in FIGS. 1-5, 23, the froster system 10 adds frosting, chilling, and/or freezing of a vessel 80 to be chilled to the ice and water dispensing features of a refrigerator 70; a CO2-dispensing nozzle 20 dispenses CO2 from a CO2 cylinder 60. In another embodiment of the invention shown in FIGS. 6-9, 24, the froster system 10 utilizes a CO2 cylinder 60 not only for adding the frosting feature, but also for adding a carbonated water dispensing feature to the refrigerator 70. A further embodiment of the invention of FIGS. 17-22, 25 provides a handheld wand 39 with a second CO2-dispensing handheld nozzle 29 that can be used with the other embodiments. Multiple aspects of the invention are also disclosed; one or more of these can be incorporated into the embodiments of the invention.

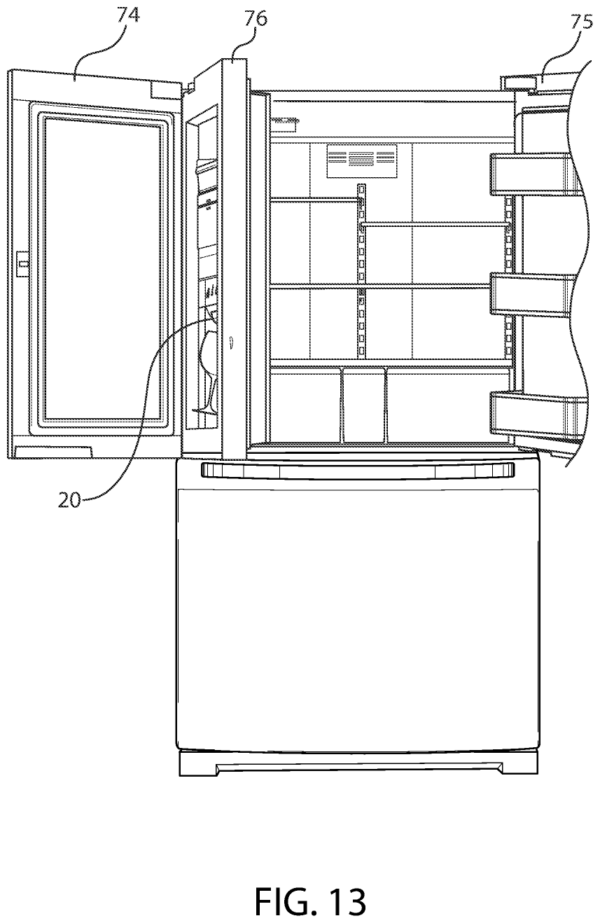

As shown in the figures, the froster system 10 of the embodiments dispenses liquid CO2 through a frosting nozzle 20 that is disposed within a refrigerator 70 and in preferable aspects of the invention, it is incorporated into a door 75 of the refrigerator 70. For example, the CO2 nozzle may be disposed on the outside of a standard outer refrigerator door 75, disposed within the outside of an inner refrigerator door 76 (such as behind a facade door 74 (FIGS. 13, 14, 18)), disposed on the inside of a refrigerator door 75, or disposed within the refrigerator interior shelf space.

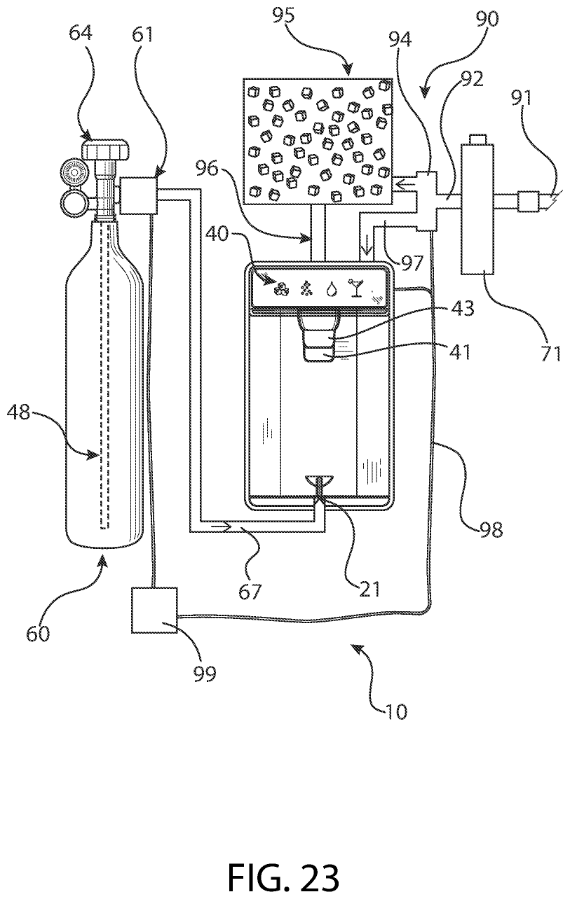

The froster system 10 efficiently sanitizes and/or chills, freezes, or ices the vessel placed at the nozzle 20. The froster system 10 includes a high-pressure CO2 cylinder 60 in fluid communication with a frosting nozzle 20, a valve 64 operated by a flow controller 99 (FIGS. 23-25) to allow, prevent, and regulate CO2 flow, and cylinder-to-nozzle connection tubing 67 (that is preferably insulated) to connect the cylinder 60 to the frosting nozzle 20.

In a further embodiment, the dispensing of carbonated water is added to the previous embodiment. A carbonated water storage tank 78 is fluidly connected to the CO2 cylinder 60 and is fluidly connected to a carbonated water dispenser. The carbonated water dispenser is preferably located in the refrigerator dispenser area 50, though it may be located elsewhere within the refrigerator. It outputs carbonated water from the carbonated water tank 78, which stores water that has been carbonated with CO2 from the CO2 cylinder 60. Thus, in this further embodiment the CO2 cylinder 60 has a double use, both for providing frosting/chilling and for providing the means to produce sparkling water.

An additional embodiment of the invention adds a handheld wand 39 that carries a second CO2-dispensing nozzle 29. The handheld wand 39 can be extended from the refrigerator the length of the wand-to-CO2 connector hose 19 to allow the froster system 10 to be used with non-standard containers or objects.

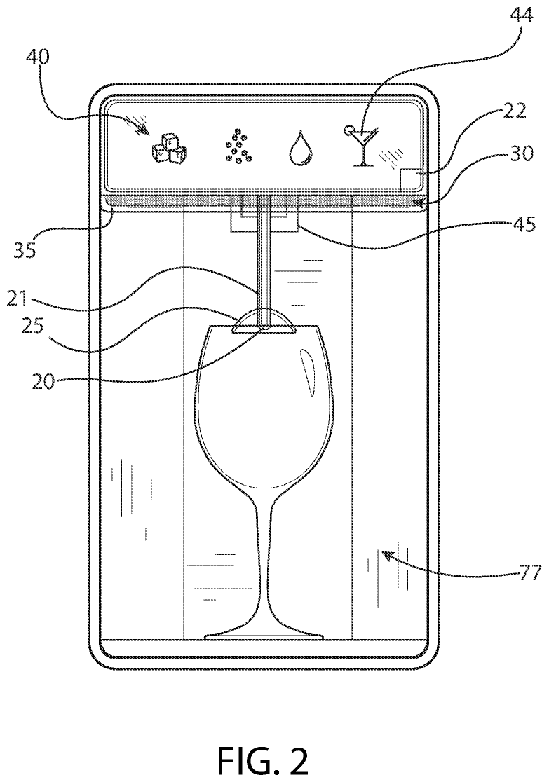

FIG. 2 shows a close-up view of the dispenser area 50 of a refrigerator door 75. The top surface, bottom floor platform, and side walls of the dispenser area 50 define a dispensing space 77 that is inset within the refrigerator door 75 that is large enough to receive a at least the upper portion of a container, such as a drinking vessel 80, that is to be chilled. In one aspect of the invention, this dispensing space 77 is larger than the dispensing space 77 of a conventional dispensing area 50, which may be desirable to enable the frosting of larger drinking vessels 80. In a preferred aspect of the invention, the bottom floor platform of the dispenser area 50 provides a substantially flat location where the drinking vessel can be rested for frosting or for filling with water or ice. In another aspect of the invention, the dispenser area 50 is smaller, and the container to be frosted may be manually held. Inside the dispenser area 50 is an ice/water dispenser 45 that typically includes a water outlet for providing cold water and a chute for dispensing cubed or crushed ice, but that, in the inventive froster system 10, additionally includes a frosting nozzle 20 for dispensing CO2.

In one type of refrigerator 70, the refrigerator 70 has an upper compartment that is accessed by a set of refrigerator doors 75 and may have one or more lower compartments, such as a freezer compartment. Another type of refrigerator 70 is a side-by-side type, which has a first side compartment that is a refrigerated side and has a second side compartment that is a freezer side. Other types of refrigerators are also known in the art. Typically, in all types of refrigerators 70, the ice/water dispenser system 45 includes an ice chute through which the crushed ice, cubed ice, and water may be dispensed. The present invention adds CO2 for frosting/chilling of a container with the CO2 nozzle 20 located to allow the CO2 to be dispensed through a modified ice and water chute assembly or to be dispensed through a separate outlet.

In one aspect of the invention, the dispensing area comprises a selection control panel 40 to allow the user to select between the water, cubed ice, crushed ice, and glass frosting/chilling modes. Typically, the selection control panel 40 is disposed adjacent to or near the dispenser area. In an aspect, the selection control panel 40 includes multiple manually engageable selection activators for water, crushed ice, cubed ice, and a CO2 activator 44 to start the CO2 dispersal for frosting; it may also include a display on a front surface for displaying data related to the froster system 10 and to the operation of the refrigerator 70. When a selection activator is engaged, the corresponding water, crushed ice, cubed ice, or CO2 is dispensed into the drinking vessel held below the corresponding outlet or resting on the bottom surface of the dispensing area 50.

In one embodiment, a safety code can be entered into a code input device, such as within the selection control panel 40, to unlock the frosting system 10 to allow CO2 for frosting to be dispensed. The code input device is configured to restrict access to the CO2-dispensing nozzle 20 and is configured to receive a safety code to allow access to the CO2-dispensing nozzle 20. The safety code feature may find particular usage in households with children. In an aspect, the safety shield may be locked in an extended position to prevent access to the CO2-dispensing nozzle, and a safety code may be required to retract the safety shield.

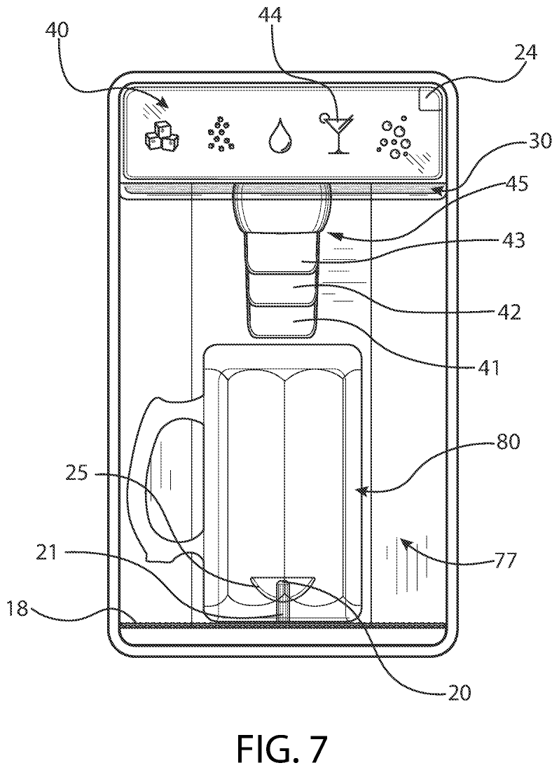

In a further aspect of the invention shown in FIG. 6, an alternate selection means is disclosed in which levers 41, 42, 43 are coupled to the top of the dispensing area 50. The levers are rotatable between at least a first position and a second position and are electrically connected to a controller 99. The controller 99 is functional to receive a signal that identifies the lever position and is functional to control the ice/water dispenser system 45 and the froster system 10 to respond with an operation corresponding to the received signal. For example, levers 41, 42, 43 can be depressed to select between the water, cubed ice, crushed ice, and glass frosting modes, with the corresponding water, crushed ice, cubed ice, or CO2 then dispensed into the drinking vessel. For example, when lever 41 is pushed with a drinking vessel, still water may be dispensed, but when lever 42 is depressed, sparkling water may be dispensed. The levers can be used alone for selection and dispensing, and, in this case, the selection control panel 40 preferably has a display on its front surface that indicates the product being output (and may also display other refrigerator information). Or the levers can be used in conjunction with the selection control panel 40. For example, the selection activator 49 (FIG. 6) may be activated to start the CO2 frosting process, but a lever 41 may be used to initiate the water output. This is shown in the aspect of FIG. 7 in which the levers 41, 42, 43 are depressed to select between the water, cubed ice, and crushed ice, but the glass frosting mode is activated by selecting CO2 activator 44.

FIGS. 1-6, 11-19 illustrate an aspect of the present invention in which the CO2-dispensing nozzle 20 is located at the top of the dispenser area 50. In this aspect, the nozzle 20 can be manually or mechanically lowered extended to the specific desired position within the vessel 80 to be chilled to optimize the effect of the CO2 for frosting. When electronically and/or mechanically controlled, an extending and contracting activator 22 (FIG. 6) (which may be one or more buttons or switches) is configured to cause (such as via a small electric motor) the nozzle 20 to extend the nozzle extension tube 21 or to retract the nozzle extension tube 21 to raise or lower the nozzle 20. When manually controlled, the nozzle 20 may be manually lengthened and the nozzle extension tube 21 may be retracted by a spring mechanism. The nozzle extension tubing 21 may be flexible or rigid. This extendable nozzle 20 provides the advantage that any size of vessel 80 (including various glasses, mugs, and/or containers) can be accommodated.

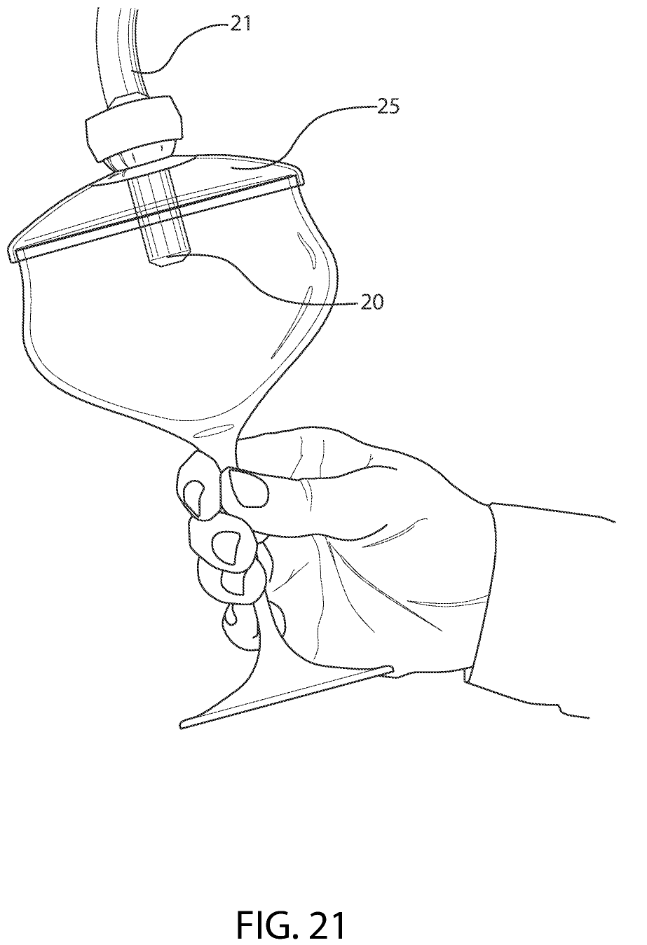

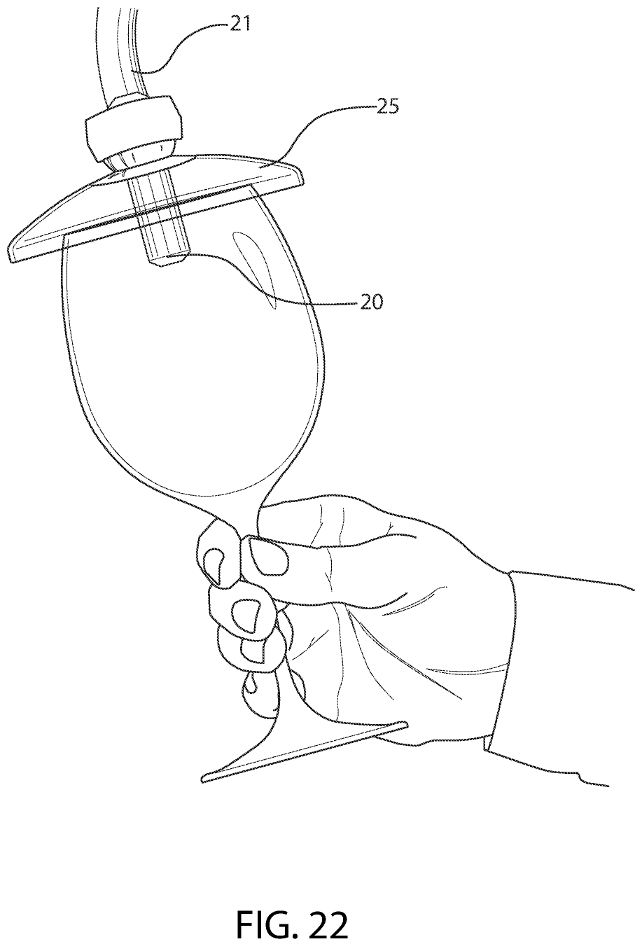

Preferably, the CO2-dispensing nozzle 20 is fitted with a nozzle guard 25. The nozzle guard 25 serves to minimize engagement of the nozzle 20 with the vessel 80 to be chilled, which prevents breakage. The nozzle guard 25 may be shaped as a segment of a circle (as shown) or may take other shapes; or it may be formed of projections extending outwardly from the nozzle 20. The nozzle guard 25 may be designed to fit within the vessel 80 to be chilled, as shown in FIGS. 1-9 and 20, or the nozzle guard 25 may be designed to fit over the top of the vessel 80, as shown in FIGS. 21-22. In the aspect in which the nozzle guard 25 fits within the vessel 80, the nozzle guard 25 is preferably formed of a resilient material, such as silicone, natural or manufactured rubber-type material, resilient or flexible plastic material, or the like, or may be formed of a combination of materials that provide at least a degree of flexibility or resilience. In the aspect in which the nozzle guard 25 fits over the vessel 80, the nozzle guard 25 may be formed of a resilient material or of a rigid material. The nozzle guard 25 may be transparent (as shown), translucent, or opaque.

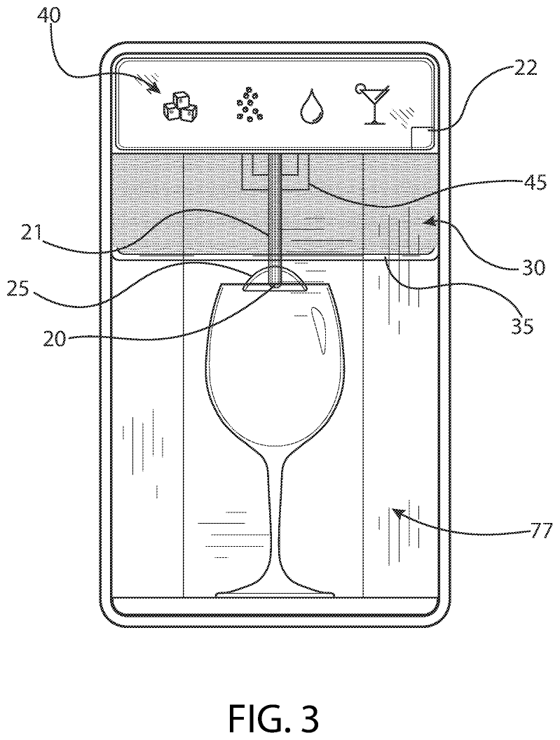

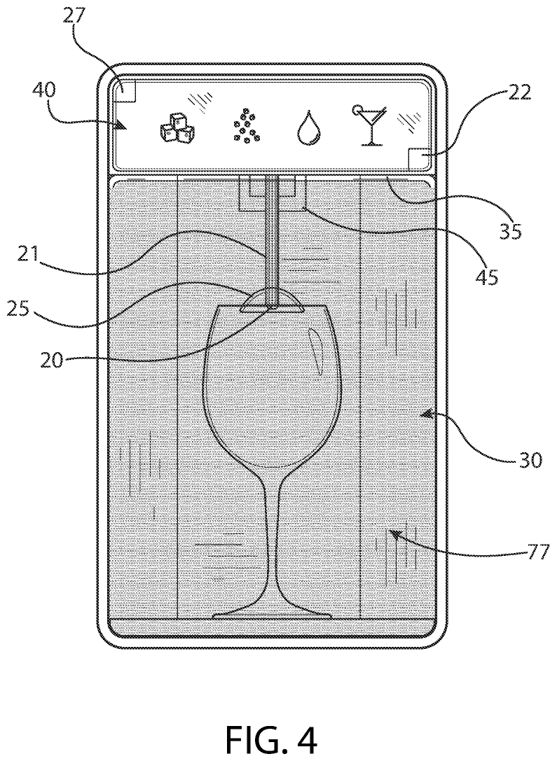

FIG. 2-8 show a safety shield 30 that is retractable and extendable. It is fully retracted in FIG. 2. The safety shield 30 is shown partially extended in FIG. 3 and fully extended in FIG. 4. The safety shield 30 is sized to fit over the front of the inset dispensing area 50. When the safety shield 30 encloses the front, it prevents the CO2 frost from endangering the user of the frosting system 10.

The safety shield 30 is preferably a plastic or acrylic sheet that can be easily shifted to cover the opening of the dispenser space 77 to prevent injury to a person from the CO2 liquid. The safety shield 30 may be solid or may preferably be a perforated sheet. When it is a perforated sheet, the CO2 gas is able to vent through the perforation holes. The perforation holes are preferably small enough that a child cannot insert a finger into the dispenser area 50 through a perforation hole. If the safety shield 30 is a solid sheet, then a vent for the CO2 is provided elsewhere in the dispenser space 77.

In the retracted storage position, the safety shield 30 is slid into a storage slot within the refrigerator door 75. In the extended in-use position the distal portion of the safety shield 30 is moved from at or near the storage slot and to a location closing the front of the inset dispenser area 50.

The extension of the safety shield 30 may be accomplished manually, or it may be automated. As seen in FIGS. 2-3, a shield lip 35 extends slightly forward from the safety shield distal end to provide an element that can be grasp or pulled against to manually lower the safety shield 30. FIG. 4 illustrates an automated extension and retraction aspect of the safety shield 30. A shield extending/retracting activator 27 (FIG. 4), which may be one or more switches or buttons, can be engaged to raise or lower the safety shield 30. The shield extending/retracting activator 27 actuates a small electric motor disposed within the refrigerator or refrigerator door 75 that is functional to raise and lower the shield 30.

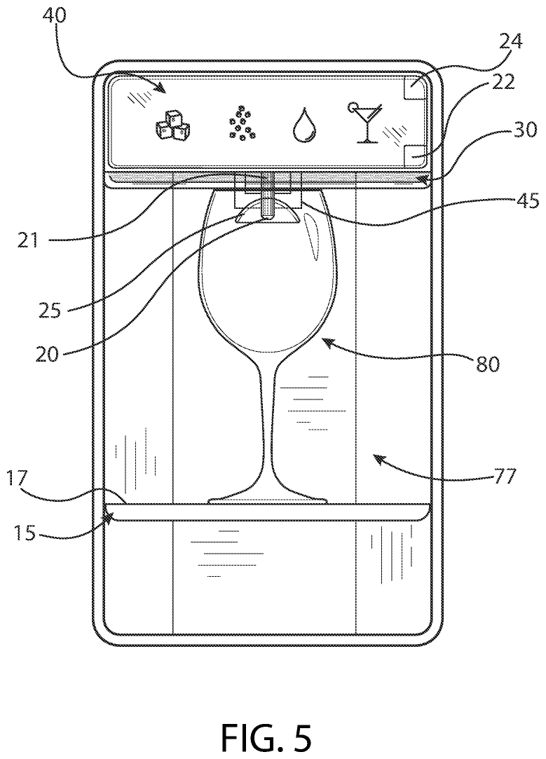

FIG. 5 illustrates an aspect of the invention in which a movable floor platform 15 can be elevated to raise the vessel 80 to be chilled into a preferred position. The floor platform 15 may be manually raised and lowered or the repositioning may be automated. In the automated aspect, a platform control activator 24 (FIG. 5) is accessible to the user, who can then raise and lower the floor platform 15 as desired. The platform control activator 24 actuates a small electric motor disposed within the refrigerator or preferably the refrigerator door 75. The motor is functional to raise and lower the platform floor 15.

In one aspect of the invention, the platform floor 15 is configured to move up and down while the CO2-dispensing nozzle 20 is fixed in position. In another aspect of the invention, both the platform floor 15 and the nozzle 20 are movable.

FIGS. 2-5 illustrate the aspect of the invention in which the nozzle 20 is aligned with the ice chute and the water outlet and may be considered a part of the ice/water chute assembly. FIG. 6 illustrates an aspect of the invention in which the CO2-dispensing nozzle 20, which is attached to the nozzle extension tube 21, is offset from, and separate from, the water and ice outlets 45. This offset positioning provides side-by-side dispensing areas within the inset dispenser area 50 that may provide advantages to the user in ease of use due to the separation of the dispensers.

FIG. 6 also illustrates another aspect of the invention in which a safety shield 30 is stored when not in use within a lower storage and is raised upwardly when needed. The safety shield 30 of this aspect can also be manually or automatically raised or lowered.

FIG. 7 discloses an aspect of the invention in which the CO2-dispensing nozzle 20 is disposed within the bottom of the dispenser area 50. In this aspect, the vessel 80 to be chilled is positioned with its opening facing downward over the nozzle 20. Then the frosting section activator 44 is engaged to start the flow of the CO2. In this aspect, the nozzle 20 may be fixed or may be extendable. If extendable, the nozzle extension tube 21 is preferably rigid to provide better support to the nozzle 20 than a flexible tubing would provide.

Optionally, when the nozzle 20 is positioned in the bottom of the dispenser area 50, a planar sheet of mesh 18 may be disposed above the floor platform 15. This floor mesh 18 serves to allow egress points for the CO2 introduced into the frosting vessel 80 and into the interior space 77 of the dispensing area 50, so that the vessel 80 is not destabilized upon contact with the somewhat forceful ejection of liquid CO2.

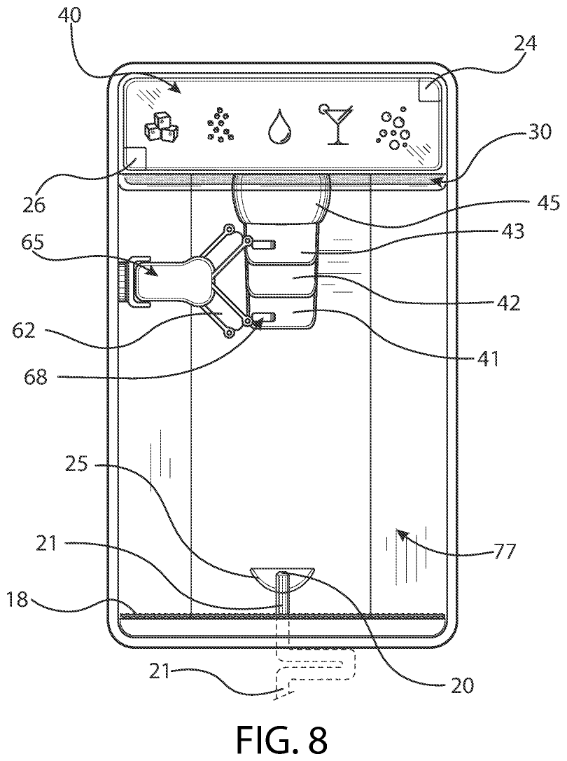

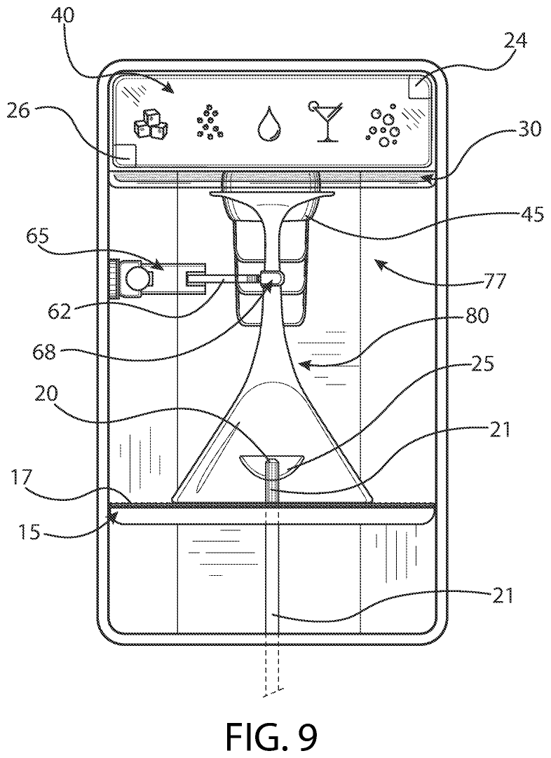

FIGS. 8-9 show a further aspect of the invention in which the frosting vessel 80 is held in place by a gripper 65, which may be a manually activated gripper or a robotic gripper. The gripper 65 preferably has arms 62 and/or fingers 68 that are designed to fold around a portion of the vessel 80 and are configured to secure the vessel 80 in place. As seen in FIG. 9, the gripper 65 can be extended toward the vessel 80 with articulated fingers 68 enveloping and/or securing a portion of the vessel 80. The floor platform may be fixed, or alternatively, as shown in FIG. 9, it may be vertically movable to be positioned upward to fit a particular glass or downward for a larger vessel 80 or for removal of a vessel 80. In one embodiment, one or more sensors are integrated into the gripper system to provide precise control of the opening, gripping, closing, opening, and releasing of the gripper arms 62 and/or fingers 68 and/or to provide control of the movable floor 15.

The gripper 65 is activated by the user via the gripper activator 26 (FIG. 9), which is functional to control the gripper 65. The use of the gripper 65 protects the user from unwanted exposure to the CO2 liquid.

The CO2 cylinder 60 is fluidly attached to the CO2-dispensing nozzle 20 via cylinder-to-nozzle tubing 67 (FIGS. 23-25), which is preferably insulated. The CO2 cylinder 60 can be disposed in any convenient location with the location based on factors such as available space, economic considerations, user accessibility for changing the cylinder 60, length of cylinder-to-nozzle tubing 67 required, and the like.

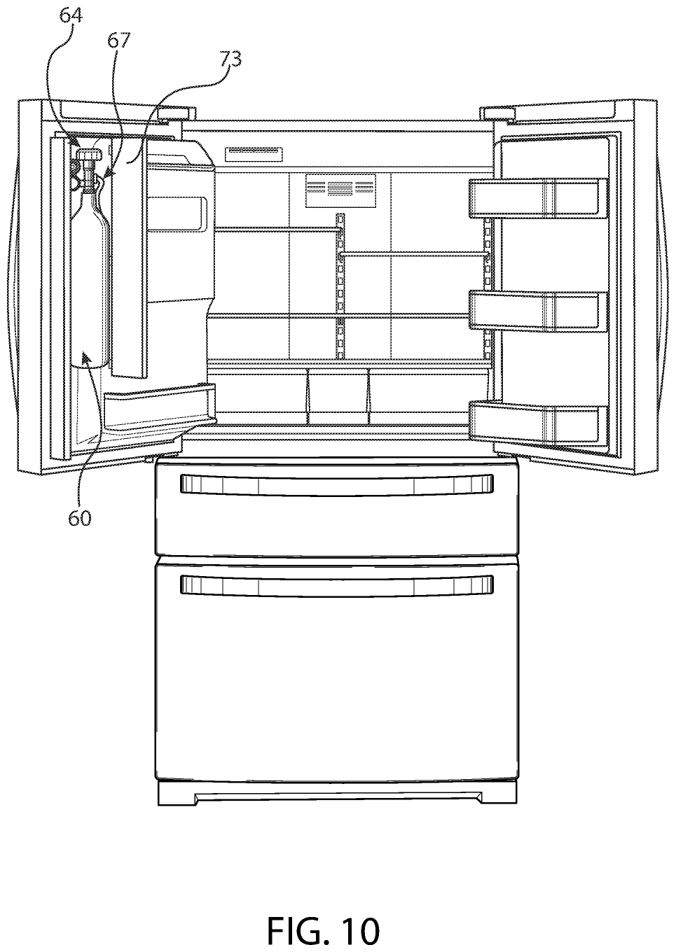

In the aspect shown in FIG. 10, the cylinder 60 is disposed within the inside of the refrigerator 70 and is specifically disposed within the inner portion of the refrigerator door 75. The interior of the refrigerator door 75 is configured with an indentation sized and configured to receive the CO2 cylinder 60. In one aspect, the CO2 cylinder 60 is installed in a vertical orientation with the CO2 cylinder 60 opening to the top, as shown in FIGS. 10-11, 23-24. In this aspect, the CO2 cylinder 60 includes a siphon/dip tube 48 to allow liquid CO2 (typically at about 700-800 PSI) to be drawn from the bottom of the CO2 cylinder 60. In this aspect, typically a dark colored ring will be disposed around the top of the cylinder to indicate the presence of a siphon tube. Typically, the top of the cylinder 60 is fitted with a manual valve that is in fluid communication with a safety relief valve. Often a pressure gauge may be installed near the pressure relief valve to monitor the outgoing CO2 pressure. Even with the use of a siphon tube 48, not all of the CO2 in the cylinder/tank can be utilized, as some CO2 remains in the gaseous state.

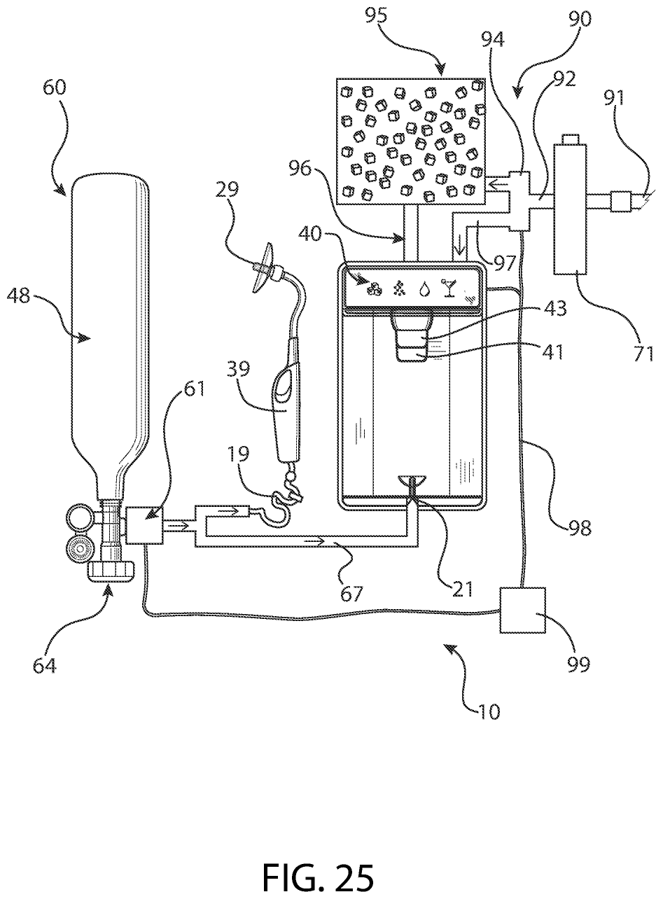

In another aspect, the CO2 cylinder 60 is installed in an inverted orientation (FIG. 25). In this aspect, the liquid CO2 will be disposed at the lower part of the cylinder, which is adjacent to the valve 61; in this orientation, a design can be engineered that does not require a siphon/dip tube.

A CO2 tank access door 73 is optional, but it provides an improved appearance. Though the cylinder 60 is shown within the door, other locations within the interior of the refrigerator are also suitable. For example, the cylinder may be positioned at the back of the shelves of the refrigerator, which would preferably be at the top back or the bottom back of the upper refrigerator compartment to minimize interference with the food goods to be stored. Preferably the cylinder 60 will not be disposed in a strictly horizontal orientation so that the siphon/dip tube 48 will be efficient to allow dispensing of the liquid CO2 (or, alternatively, so that the liquid CO2 will flow downward to the valve area for use, as in FIG. 25). Locating the cylinder 60 within the inside of the refrigerator provides the advantage that a short cylinder-to-nozzle tubing 67 can be used, and that the CO2 cylinder 60 can be easily accessed by the user for replacement when it is empty.

In another aspect, the CO2 cylinder 60 is accessed from the exterior of the refrigerator 70. One exterior location is within the refrigerator door 75, but with access from the outside of the door 75. In this aspect, a CO2 tank access door 73 is preferably provided on the upper front of the refrigerator 70 for aesthetic reasons.

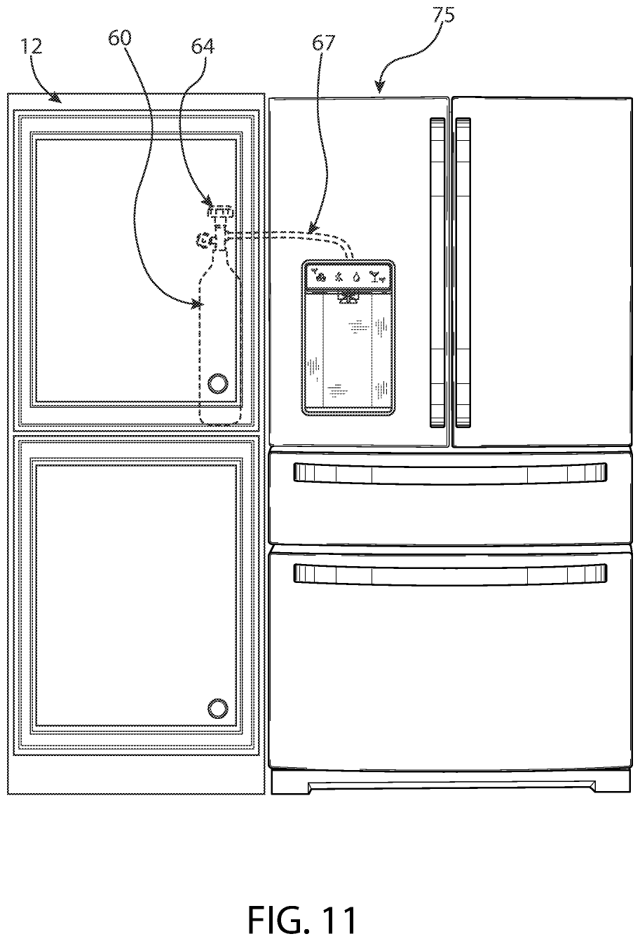

In another aspect shown in FIG. 11, the CO2 cylinder 60 is disposed within a cabinet 12 that is located near to, or adjacent to, the refrigerator 70. Though the cylinder-to-nozzle tubing 67 is longer in this aspect compared to the aspect of FIG. 10, this aspect maximizes interior refrigerator space. Though cabinet space is used, typically cabinet space is not as limited as refrigerator space. Although the CO2 cylinder 60 is shown in a cabinet 12, locating it further from the refrigerator, such as in a closet, storage area, basement, garage, under a kitchen sink, or the like, is within the scope of the invention.

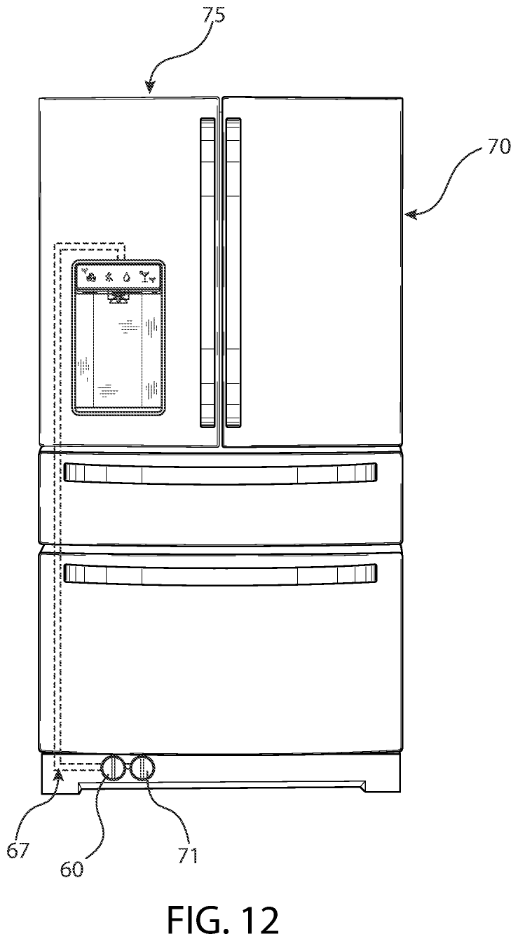

FIG. 12 illustrates yet another suitable location for the CO2 cylinder 60, which is at the base of the refrigerator 70. In one preferred location at the refrigerator base, the CO2 cylinder resides adjacent to the refrigerator water filter 71. The CO2 cylinder 60 can be accessed and conveniently changed from the front, similarly to how the water filter 71 is typically accessed and changed. This positioning also requires a longer cylinder-to-nozzle tubing 67, but it does not use interior refrigerated space. In this aspect, the cylinder 60 is preferably not horizontal. It may be disposed at an angle with the front opening higher than the back of the cylinder 60 to allow the siphon/dip tube to aid in dispensing of the liquid CO2. It may be disposed at an angle with the front opening lower than the back of the cylinder 60 to allow use of the liquid CO2 without the siphon/dip tube 48.

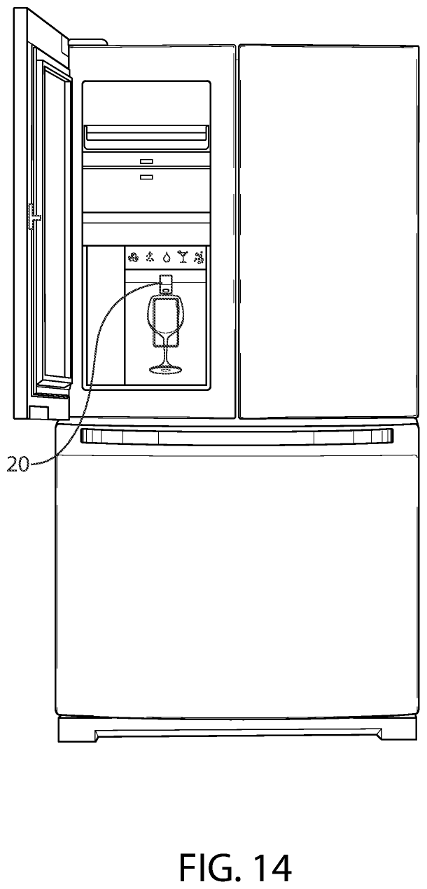

In an aspect of the invention shown in FIGS. 13-14, the CO2-dispensing nozzle 20 is disposed within the ice/water dispensing area on the front side of an inner refrigerator door 76 that is designed to be covered by a refrigerator facade door 74. This aspect may be used with any of the three embodiments.

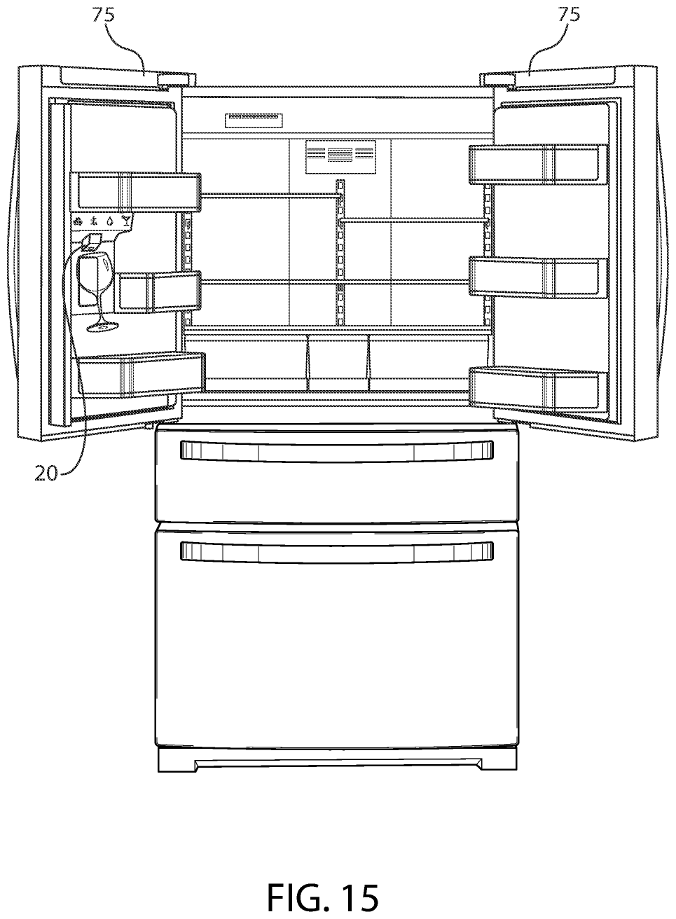

In another aspect of the invention, which is shown in FIG. 15, the CO2-dispensing nozzle 20 is disposed within an ice/water dispensing area that is located on an interior face of a refrigerator door. In a further aspect, the CO2-dispensing nozzle 20 is disposed within an ice/water dispensing area that is located in the interior of the refrigerator, such as in the side or back of the shelf area.

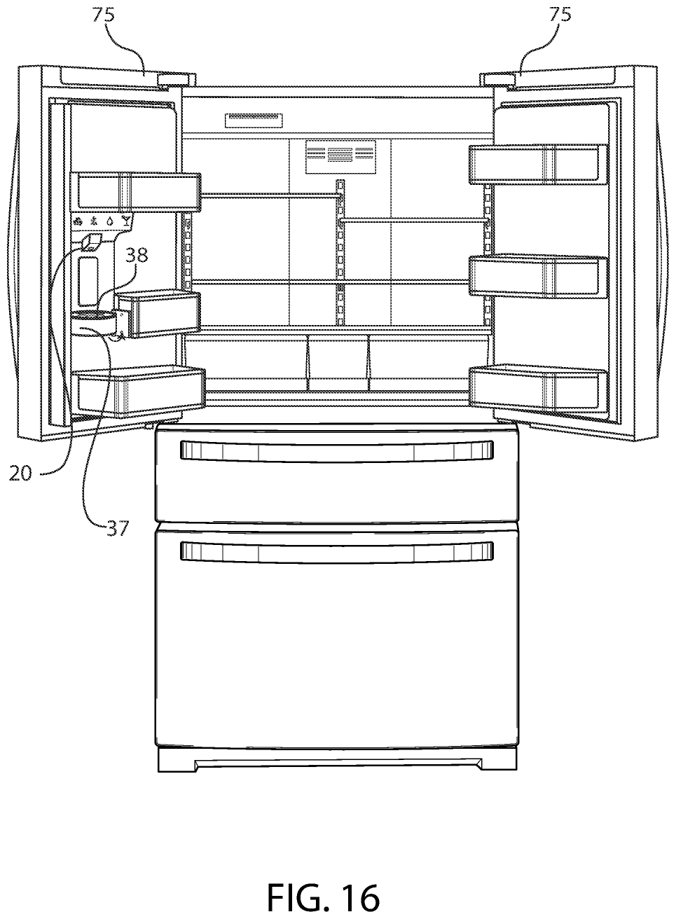

In a further aspect of the invention shown in FIG. 16, a manual gripper 65 is embodied as an extendible/retractable holder 37 for the to-be-chilled vessel 80 is provided. The extendible/retractable holder 37 that has a center opening sized to receive the article to be frosted. The article to be frosted can be positioned within the extendible/retractable holder 37, which will hold the article and protect the hands of the user. In a preferred aspect, rubber-like flaps 38 are disposed along the inner edge of the extendible/retractable holder 37, as are known to be used in car drink holders. The rubber-like flaps 38 extend inwardly a distance less than the radius of the extendible/retractable holder 37. The use of the rubber-like flaps 38 may be desired in some cases to further secure the article to be frosted. Both the gripper 65 described above and the holder-type gripper described here may be used when the ice/water dispensing area is disposed on the outside of a refrigerator door 75, on the outside of a refrigerator internal door 76 that is designed to be concealed by an outer facade door 74, within the shelf area of the refrigerator, or on an interior face of a refrigerator door (as shown in FIG. 16).

FIGS. 17-22 and 25 disclose an embodiment of the invention that provides a handheld wand 39 that carries a CO2-dispensing nozzle 20 for frosting/chilling. The wand 39 has a housing that is suitable for holding manually. Optionally but preferably, it may have a handle through which the user's fingers can be inserted. A first end of the housing of the wand 39 is fluidly connected to a wand-to-CO2 connector hose 19 (which is a specialized portion of the cylinder-to-nozzle tubing 67), and a second end of the wand 39 is in fluid communication with the CO2-dispensing nozzle 20. The CO2-dispensing nozzle 20 may be connected to the housing of the wand 39 directly or via a neck, which may optionally be flexible (as shown). The wand-to-CO2 connector hose 19 runs from the wand first end to the CO2 cylinder 60 or may connect to another portion of the cylinder-to-nozzle tubing 67 (which then connects to the CO2 cylinder 60). Thus, the CO2 cylinder is fluidly connected to the CO2-dispensing nozzle 20.

The wand 39 can be manually removed from its holder within the refrigerator and can be moved around as needed, such as to frost a large container that will not fit into the ice/water dispensing area. After use, the wand 39 can be manually replaced into its holder/retainer.

It is advantageous to have two CO2-dispensing nozzles 20 (as shown), one of which is fixedly attached in the ice/water dispensing area and one of which can be manually removed from its holder/retainer to frost articles that may not fit within the ice/water dispenser and/or that may be too heavy to lift into the ice/water dispenser area. However, a single CO2-dispensing nozzle 20 that is carried by a manually extendible handheld wand 39 is within the scope of the invention.

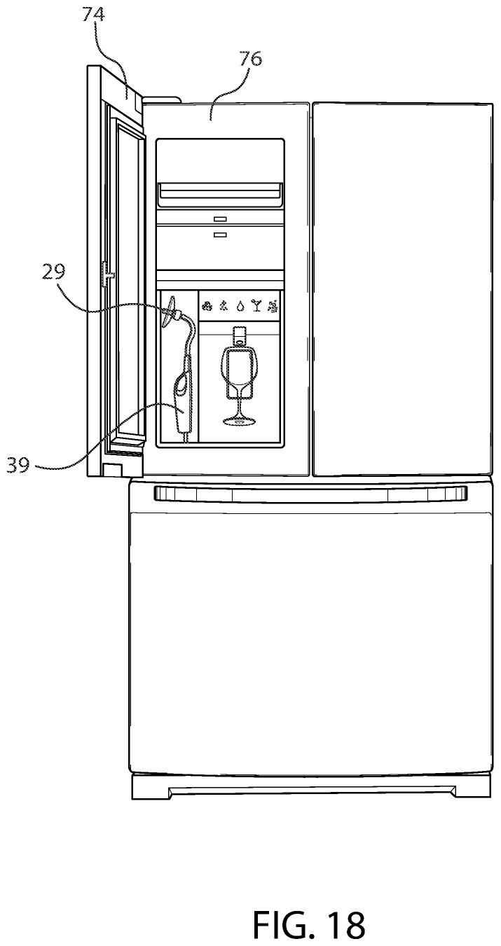

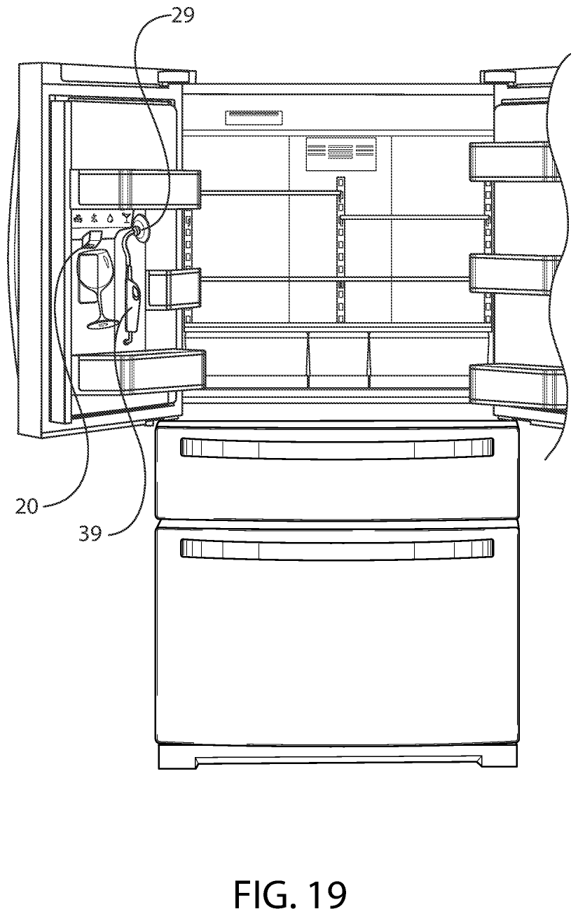

FIG. 17 shows an aspect in which the handheld wand 39 is disposed in an inset on the outside of a refrigerator door 75. FIG. 18 shows an aspect in which the wand 39 is disposed within the outside of an inner refrigerator door 76. FIG. 19 an aspect in which the handheld wand 39 is disposed in an inset on the inside of a refrigerator door 75.

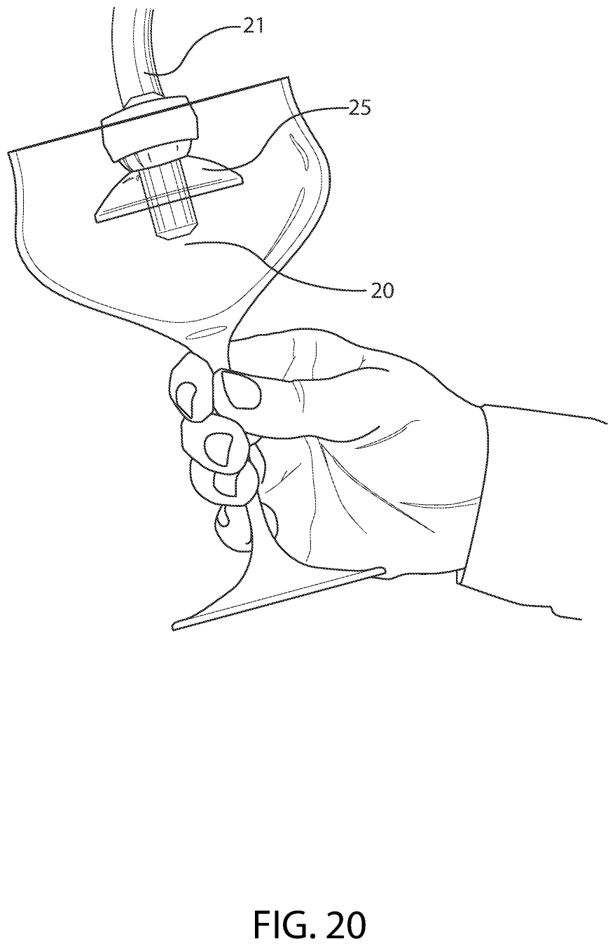

FIGS. 20-22 show that the nozzle guard 25 may be small, medium, or large in size. In FIG. 20, the nozzle guard 25 is small and acts as a bumper guard to keep the nozzle 20 from bumping into the vessel 80. In FIG. 21, the nozzle guard 25 is of a medium size which is similar in diameter to the vessels which it will frost. The medium size nozzle guard 25 acts as a loose-fitting lid to partially retain the CO2 as it is dispensed, which may allow more efficient cooling. FIG. 22 shows a larger nozzle guard 25, which serves as a hood into which the vessel 80 to be frosted is placed. This aspect of the invention may also provide more efficient cooling than the small nozzle guard 25.

The elements of one embodiment of the froster system 10 along with standard elements of an ice and water dispenser 45 are shown in the diagram of FIG. 23. Controller 99 controls the functionality of the froster system 10 and of the associated ice/water dispenser system of the refrigerator. The control circuitry 98 connects the controller 99 to the selection control panel 40 and to the various other elements of the ice/water dispenser and the CO2 froster system 10.

Water from a potable water source (such as a municipal water source or well) travels through piping 91 to enter a water purification filter 71, where it is purified before entering the water switching system 90. The water travels from the filter 71 through piping 92 to a switching valve 94 (a part of the water switching system 90) where it is directed to either the icemaker 95 or to piping 97 through which it flows to the water output in the dispenser area 50. The water directed to the icemaker 95 is frozen into ice cubes. Based on the selection made by the user at the selection control panel 40 or via the levers, CO2 for frosting/chilling is dispensed, or still water is dispensed, or ice exits the icemaker 95 through ice outlet 96 to be dispensed as cubed ice or crushed ice.

In some aspects of the invention, the CO2 cylinder 60 containing liquid CO2 has an interiorly disposed siphon/dip tube 48. The siphon/dip tube 48 extends from the top of the cylinder to near the bottom of the cylinder 60 to allow liquid CO2 to be drawn out of the cylinder 60 through valve 64 (controlled by controller 99) based on the selection made by the user at the selection control panel 40 or via the levers). When allowed by the controller 99 that regulates the valve 61, the CO2 flows through the cylinder-to-nozzle tubing 67, through the nozzle extension tube 21, and out the CO2-dispensing nozzle 20 to frost the vessel 80 to be chilled.

The CO2 cylinder 60 may contain CO2 at around 700-800 psi. If the CO2 cylinder 60 is under around 10 pounds, it may be suitably hidden within the refrigerator itself. If the CO2 cylinder 60 is over about 20 pounds, it may be more suitably held within a location remote from the refrigerator. It may be formed of any suitable material, such as aluminum, steel, and the like. Preferably, the siphon/dip tube 48 is an internal tube, but optionally, it may be an external tube. The internal siphon/dip tube 48 is similar to a straw that extends from the top of the cylinder 60 down to at or near the bottom of the cylinder 60. The CO2 gas, which is stored in its liquid state in the cylinder 60, is expelled in its liquid state.

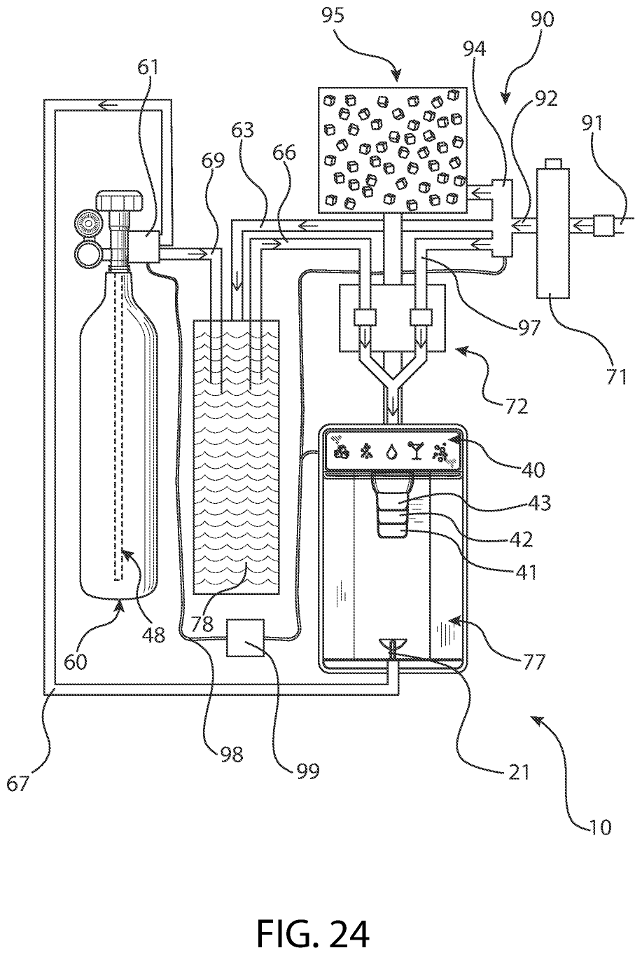

In FIG. 24, the embodiment shown in FIGS. 6-9, which includes a carbonated water tank 78 and carbonated (sparkling) water dispenser, is diagrammatically illustrated. This embodiment includes the elements of the ice/water dispenser and the CO2 dispenser of the above embodiment shown in FIG. 23. But in contrast to the embodiment of FIG. 23, the CO2 cylinder 60 supplies CO2 to both the froster system 10 and to a carbonated water dispensing system.

In this embodiment, the CO2 cylinder 60 is utilized for both frosting a drinking glass 80 and carbonating water that is stored in the carbonated water tank 78. Filtered water travels from switching valve 94 to the carbonated water tank 78 via water tank intake tubing 63. The CO2 cylinder 60 is fluidly connected via cylinder-to-nozzle tubing 67 to the CO2-dispensing nozzle 20 and is fluidly connected via cylinder-to-water tubing 69 to the carbonated water tank 78. The carbonated water tank 78 is fluidly connected via tank-to-dispenser tubing 66 to the dispenser area 50. Upon selection of sparkling water by the user (such as by lever 42), sparkling water flows from the carbonated water tank 78 to the dispensing area 50 and is dispensed. In a preferred aspect, both types of water are dispensed through the same output through the Y-shaped water selection connector 72. The type of water or type of ice may be selected by the user by the sole use of the selection control panel 40, may be selected by the sole use of the levers, or may be selected by using a combination of the two.

In an additional aspect of this embodiment of FIG. 24, the CO2 cylinder 60 is configured with two supply conduits. A first conduit outputs CO2 gas to create sparkling water. The second conduit outputs CO2 liquid, which is used for frosting. One end of the second conduit is fluidly connected to the siphon/dip tube 48, and the other end of the second conduit is fluidly connected via the cylinder-to-nozzle tubing 67 to the liquid CO2-dispensing nozzle 20. The first conduit has a first end fluidly connected to the gaseous air space within the CO2 cylinder 60 and has a second end fluidly connected via cylinder-to-water tubing 69 to the carbonated water tank 78. This inventive cylinder 60 thus serves a dual purpose by efficiently providing gaseous CO2 or liquid CO2. Though for efficient use of space, a single CO2 cylinder 60 has been described, optionally, dual CO2 cylinders 60 can be used with one supplying CO2 gas and one supplying CO2 liquid.

In FIG. 25, the embodiment whose components are shown in FIGS. 17-22 is illustrated diagrammatically. This embodiment adds the handheld wand 39 to the other aspects of the invention. The handheld wand 39 carries a second CO2-dispensing nozzle 29. The CO2 is routed from the CO2 cylinder 60 through the CO2 wand connector hose 19 through the housing of the handheld wand 39 to the CO2 nozzle 29.

Though shown in FIG. 25 as including the elements of the ice/water dispenser and the CO2 dispenser of the embodiment of FIG. 23, the handheld wand 39 may equally well be utilized with the elements of the ice/water/sparkling water embodiment of FIG. 24. In another embodiment of the invention, the handheld wand 39 carrying the second CO2 nozzle 29 is used as the sole source of CO2 for frosting/chilling without the first CO2 nozzle 20; in this embodiment, the handheld wand 39 functions to provide CO2 for chilling, but it not integrated into the conventional ice/water dispenser area.

In an exemplary method of use of the froster system 10 of the invention, the user installs a CO2 cylinder 60 containing CO2 liquid that allows CO2 in the liquid state to be dispensed. The user selects a vessel 80 to be chilled, such as a mug, tumbler, or other drinking glass. In the aspect in which a safety code is required to unlock the froster system functionality, a user first inputs the safety code, such as by use of the selection control panel 40.

Then the user obtains a vessel 80 to be chilled. When using the CO2 nozzle 20 in the dispensing area for chilling, the user brings the vessel 80 near the refrigerator, positions the vessel 80 with at least a portion of the vessel 80 disposed within the dispensing area 50, and aims the nozzle 20 into the vessel or orients the nozzle 20 into the vessel 80 in a suitable position for chilling. In the embodiment in which the handheld wand is to be used for chilling, the user brings the vessel 80 near the refrigerator and aims the nozzle 20 into the vessel or orients the nozzle 20 into the vessel 80 in a suitable position for chilling.

In the aspect in which the nozzle guard 25 is inserted into the vessel 80, the nozzle guard 25 protects the vessel 80 in case the nozzle 20 is inadvertently bumped against the vessel 80.

In some aspects of the invention, the user extends the nozzle 20 by lengthening the nozzle extension tube 21 or extends the wand-to-CO2 connector hose 19, which may be done manually, or by mechanically by actuating the extending and contracting activator 22. This extension of the nozzle 20 allows a greater variety of sizes and shapes of vessels to be chilled.

Preferably, the user places the nozzle 20 in the preferred location, which is just below the rim of the vessel 80. Depending on the glass size and thickness, the CO2 will be applied to the vessel 80 for approximately three to ten seconds with the length of time dependent on factors such as the output volume of the CO2 gas and the thickness of the vessel 80 to be frosted. For example, a mug is thicker than a drinking glass, so it will require a few extra seconds of frosting.

In the aspects of the invention which include a safety shield 30, the user may slide the safety shield 30 over the front of the dispenser area 50 to enclose the area to provide safety to the user. Then the user may manually slide the safety shield 30 from its storage slot (on the top, side, or bottom of the area 50) or the user may activate an electronic and/or mechanical sliding mechanism to extend the safety shield 30. After closing the front of the area 50, the user activates the frosting system 10 to cause the liquid CO2 to be expelled from the CO2-dispensing nozzle 20. The vessel 80 is frosted. The user may manually hold down a switch to control the length of time that the dispensing of the CO2 will continue. Alternatively, a timer may be provided to control the length of time that the CO2 is dispensed. The user then manually or electronically/mechanically retracts the safety shield 30 and retrieves the frosted vessel 80.

In one aspect of the invention, the user manually holds the vessel 80 within the dispensing area 50 and activates the CO2 frosting system 10, which causes liquid CO2 to be dispensed from the CO2-dispensing nozzle 20 onto the vessel 80. The user may turn the vessel 80 to optimize and even out the frosting. The user may optionally use gloves, hot pads, or dishtowels to protect his or her hands from the cold, if desired.

In another aspect of the invention that is shown in FIGS. 7-8 and 16, the user may place the vessel 80 to be chilled within the dispensing area 50 and activate a mechanical or robotic gripper 65 to grip and hold the vessel while chilling. In an embodiment, the gripper's arm 62 and/or articulated fingers 68 are actuated to hold, encircle, or otherwise secure the vessel 80. After frosting, the user deactivates the gripper 65 to release the vessel 80. In another embodiment, the rubber-like flaps 38 hold, encircle, or otherwise secure the vessel 80. After frosting the vessel 80, the user removes the vessel 80 from the rubber-like flaps 38.

In a further aspect of the invention shown in FIG. 5, the user has the option of raising the floor platform 15 and placing the vessel 80 on the top surface 17. This optional aspect of the invention allows for convenient positioning. The user may manually raise the floor platform 15, but preferably the user engages a floor platform activator 24 to automatically raise the floor platform 15. After raising the floor platform 15, the user positions the vessel 80 appropriately for frosting (which may include manipulating the nozzle 20 to a desired position), optionally closes the dispensing area 50 with the safety shield 30, and activates the froster system 10 to cause CO2 to be expelled onto the vessel 80, such as by activating the CO2 activator 44. The length of frosting time may be manually controlled by the length of time the user depresses the CO2 activator 44 or may be automatically controlled by a timer. After frosting the vessel 80 the user opens the safety shield 30 (if closed) and removes the frosted vessel 80.

When the CO2-dispensing nozzle 20 is disposed within the floor platform 15 as in FIG. 7, the user positions the vessel 80 onto mesh sheet 18 before closing the safety shield 30.

When the amount of CO2 in the CO2 cylinder 60 becomes depleted, the user will access the CO2 cylinder 60 to remove the depleted cylinder 60. If the cylinder 60 is behind a CO2 tank access door 73, the user will open the door 73 to retrieve the used cylinder 60. If the depleted cylinder 60 is located in the base of the refrigerator, the user disconnects it from its fitting there. If the CO2 cylinder 60 is in a location remote to the refrigerator, the user will retrieve the used cylinder 60 from this remote location. Removing the cylinder 60 typically involves threading the fitting off the neck of the cylinder 60. Then a replacement cylinder 60 filled with CO2 is obtained, and it is installed in the location from which the depleted cylinder was removed.

The invention illustratively disclosed herein suitably may be practiced in the absence of any element which is not specifically disclosed herein.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A froster system for chilling or icing a vessel, comprising:
cylinder-to-nozzle tubing that is fluidly attachable to a CO2 cylinder containing liquid CO2; and
a CO2-dispensing nozzle that is disposed within a refrigerator, that is fluidly attached to the cylinder-to-nozzle tubing, and that dispenses liquid CO2 for chilling or icing the vessel.

2. The froster system of claim 1, wherein the CO2-dispensing nozzle is disposed within an ice/water dispensing area of the refrigerator.

3. The froster system of claim 2, wherein the ice/water dispensing area is disposed within a refrigerator door.

4. The froster system of claim 2, wherein the ice/water dispensing area comprises a floor platform that can be raised and lowered.

5. The froster system of claim 2, further comprising a safety shield that extends to cover the ice/water dispensing area.

6. The froster system of claim 5, wherein the safety shield is perforated.

7. The froster system of claim 1, further comprising a code input device that is configured to restrict access to the CO2-dispensing nozzle and is configured to receive a safety code to enable access to the CO2-dispensing nozzle.

8. The froster system of claim 1, wherein:
the froster system further comprises the CO2 cylinder; and
the CO2 cylinder comprises a liquid CO2 conduit providing liquid CO2 for chilling or icing the vessel and a gas CO2 conduit providing gaseous CO2 for sparkling water.

9. The froster system of claim 1, wherein:
the froster system further comprises the CO2 cylinder; and
the CO2 cylinder comprises a siphon tube disposed within an interior area of the CO2 cylinder.

10. The froster system of claim 1, further comprising a guard disposed at the CO2-dispensing nozzle; wherein the guard is formed of a resilient material.

11. The froster system of claim 1, wherein the CO2 cylinder is removable and replaceable and is disposed within the refrigerator.

12. The froster system of claim 1, wherein the CO2 cylinder is removable and replaceable and is disposed in a remote location that is not within the refrigerator.

13. The froster system of claim 1, further comprising a handheld wand type CO2 nozzle.

14. A method to chill or ice a vessel, comprising:
positioning the vessel near a refrigerator;
positioning a CO2-dispensing nozzle in, or aimed at, the vessel; wherein the CO2-dispensing nozzle is disposed within a refrigerator; and
activating dispersal of liquid CO2 from the CO2-dispensing nozzle that is fluidly attached to a high-pressure CO2 cylinder to cause chilling or icing of the vessel.

15. The method of claim 14, wherein the CO2-dispensing nozzle is disposed within an ice/water dispensing area of the refrigerator.

16. The method of claim 15, further comprising:
extending a safety shield to cover at least part of the ice/water dispensing area before activating dispersal of liquid CO2.

17. The method of claim 15, further comprising:
raising or lowering a floor platform of the ice/water dispensing area.

18. The method of claim 14, further comprising:
inputting code into a code input device that is configured to allow and prevent access to the liquid CO2.

19. The method of claim 14, further comprising:
obtaining sparkling water from the refrigerator; wherein the high-pressure CO2 cylinder provides CO2 to produce the sparkling water.

20. The method of claim 14, further comprising:
opening a refrigerator facade door to access the CO2-dispensing nozzle disposed behind the refrigerator facade door.

21. The method of claim 14, further comprising:
positioning a handheld wand type CO2 nozzle into, or aimed at, an object to be chilled or iced; and
activating dispersal of liquid CO2 from the handheld wand type CO2 nozzle that is fluidly attached to the high-pressure CO2 cylinder.
